(19) United States
(12) Patent Application Publication
(10) Pub. No.: US 2011/0054724 A1
(43) Pub. Date: Mar. 3, 2011

(54) METHOD FOR OPTIMIZING THE UTILIZATION OF AN ENERGY STORE CONNECTED TO AN ELECTRIC MACHINE

(76) Inventors: Mesut Er, Friedrichshafen (DE); Stefan Wallner, Mattsee (AT); Notker Amann, Friedrichshafen (DE)

(21) Appl. No.: 12/743,786

(22) PCT Filed: Oct. 22, 2008
(86) PCT No.: PCT/EP08/64231

§ 371 Date: Nov. 4, 2010

(30) Foreign Application Priority Data
Nov. 20, 2007 (DE) 102007047822.6

(51) Int. Cl. G06F 7/00

(52) U.S. Cl. 701/22; 180/65.25; 903/903

(57) ABSTRACT

A method is proposed for optimizing the utilization of the energy store which is connected to the electric machine of a parallel hybrid vehicle, in the scope of which method different lower limits are defined or predefined for the operation of the energy store, wherein a priority is assigned to each vehicle function which requires electric power in order to be performed, wherein different lower energy storage limits are assigned to different priorities in such a way that the energy storage limits are reduced for vehicle functions having a relatively high priority, with the result that said functions are carried out within the physical limits of the energy store.

The present invention relates to a method for optimizing the utilization of the energy store which is connected to the electric machine of a parallel hybrid vehicle, according to the preamble of patent claim 1.

Hybrid vehicles comprising a hybrid transmission are known from the prior art. They comprise at least one electric motor or electric machine in addition to the internal combustion engine. In the case of serial hybrid vehicles, a generator is driven by the internal combustion engine, wherein the generator supplies electrical energy to the electric motor which drives the wheels. Furthermore, parallel hybrid vehicles are known in which the torques of the internal combustion engine and of at least one electric machine which can be connected to the internal combustion engine are added. In this context, the electric machines can be connected to the belt drive or to the crankshaft of the internal combustion engine. The torques which are generated by the internal combustion engine and/or the at least one electric machine are transmitted to the driven axle via a transmission which is connected downstream.

The prior art discloses that the energy store which is connected to the electric machine of a hybrid vehicle is operated within fixed limits, wherein these limits are determined during the configuration of the system and apply to the entire operational period. In this context, the limits must be selected in such a way that the operation of the battery within these limits is operated in such an energy-saving fashion that the required service life is reached on average. As a rule, the limits are selected conservatively in order to reach the required service life, this occurring at the expense of optimum utilization of the battery.

The fact that requirements made of the hybrid system, for example the requirement to start the internal combustion engine can no longer be carried out when the lower limit, defined for the operation of the energy store (the limit may be, for example, a charge state value or a value for the stored electric power) is exceeded since the energy store no longer makes available any power, is disadvantageous in this case.

The present invention is based on the object of specifying a method for optimizing the utilization of the energy store which is connected to the electric machine of a parallel hybrid vehicle and the performance of which can ensure that the power which is necessary for implementing important functions of the drive chain is made available within the physical limits of the energy store.

This object is achieved by means of the features of patent claim 1. Further embodiments and advantages according to the invention emerge from the subclaim.

Accordingly, a method is proposed in the scope of which different lower limits are defined or predefined for the operation of the energy store and a priority is assigned to each vehicle function which requires electric power in order to be performed, wherein different lower energy storage limits are assigned to different priorities in such a way that the energy storage limits are reduced for vehicle functions having a relatively high priority.

As a result of the prioritization conception according to the invention, it is advantageously possible to make available energy or power for the more important functions, while functions with a lower priority are not permitted. For example, a high priority is to be given to carrying out starting of an internal combustion engine, with the result that the lower limit of the energy store is reduced in order to permit starting of the internal combustion engine for as long as possible.

Furthermore, the prioritization ensures that the optimum limits for the energy store which are determined during the configuration of the system are not touched for the purpose of carrying out “unimportant” functions, i.e. ones which are of low priority.

Within the scope of one advantageous development of the invention, the limits can be permanently parameterized in the energy storage module or can be changed dynamically as a function of the energy storage state or vehicle state.

Performing the method presented here permits important vehicle functions or vehicle functions which have high priority to be performed within the physical limits of the energy store.

Furthermore, if the energy storage limits are increased or made tighter for functions with a low priority and optionally for functions with a normal priority, the energy storage service life can be increased. In addition, the energy storage service life is increased since owing to the prioritization of the functions the necessity to carry out loading of the energy store in critical regions will occur less frequently.

Within the scope of one development of the invention it is possible to provide that the upper limit for the operation of the energy store is also changed as a function of the prioritization of the vehicle functions, with the result that the upper energy storage limit is increased for functions with a relatively high priority.

1. A method for optimizing the utilization of the energy store which is connected to the electric machine of a parallel hybrid vehicle, characterized in that different lower limits are defined or predefined for the operation of the energy store, and in that a priority is assigned to each vehicle function which requires electric power in order to be performed, wherein different lower energy storage limits are assigned to different priorities in such a way that the energy storage limits are reduced for vehicle functions having a relatively high priority, with the result that said functions are carried out within the physical limits of the energy store.

2. The method for optimizing the utilization of the energy store which is connected to the electric machine of a parallel hybrid vehicle, characterized in that the limits are permanently parameterized in the energy storage module or are changed dynamically as a function of the energy storage state or vehicle state.
